(19) United States
(12) Patent Application Publication
(10) Pub. No.: US 2017/0339343 A1
(43) Pub. Date: Nov. 23, 2017

(54) MULTI-FUNCTIONAL CAMERA

(71) Applicant: Tijee Corporation, Bellevue, WA (US)

(72) Inventors: Yong Zhang, Bellevue, WA (US); Wenjun Wang, Sammamish, WA (US)

(21) Appl. No.: 15/469,250

(22) Filed: Mar. 24, 2017

Related U.S. Application Data
(60) Provisional application No. 62/337,363, filed on May 17, 2016.

(51) Int. Cl. H04N 5/232; H04N 5/33; H02J 50/40; H02J 50/10; H02J 7/02; H04N 7/18; H04N 5/225

(52) U.S. Cl. CPC H04N 5/23241; H04N 7/188; H04N 7/181; H04N 5/33; H04N 5/2258; H02J 50/10; H04N 5/2252; H02J 7/025; H02J 50/40; H04N 5/2253

(57) ABSTRACT

A multi-functional camera with various power adapters may capture images/video with corresponding environmental data. The multi-functional camera may implement wireless charging, and enable limited surveillance functionalities under a power saving mode.

### RELATED APPLICATION

This application claims priority under 35 U.S.C. §119 to U.S. Provisional Application No. 62/337,363, filed May 17, 2016, entitled “Multi-Functional Wireless Camera with Various Power Attachment Adapters,” the disclosure of which is incorporated by reference herein in its entirety.

### BACKGROUND

The disclosed technology relates to cameras. More particularly, the disclosed technology relates to multi-functional camera(s) with various power adapters to allow a surveillance system to conveniently capture rich environmental data.

Conventional wireless Internet Protocol cameras (IPCs) do not provide rich environmental information related to scenes captured in video/images for advanced applications to further process. Conventional IPCs also need a consistent power supply, which results in high installation costs and may cause loss of surveillance functions in the event of a power outage.

### BRIEF DESCRIPTION OF THE DRAWINGS

FIG. 1 is an illustration of a wireless charging model of a multi-functional camera in accordance with some implementations of the disclosed technology.

FIG. 2 is an illustration of a wired charging model of a multi-functional camera in accordance with some implementations of the disclosed technology.

FIG. 3 is an illustration of a side view of a camera body in accordance with some implementations of the disclosed technology.

FIG. 4 is an illustration of a top view of a camera body in accordance with some implementations of the disclosed technology.

FIG. 5 is an illustration of a bottom view of a camera body in accordance with some implementations the disclosed technology.

FIG. 6 is an illustration of a side view of a power charger insert in accordance with some implementations of the disclosed technology.

FIG. 7 is an illustration of a top view of a power charger insert in accordance with some implementations of the disclosed technology.

FIG. 8 is a block diagram of a camera body in accordance with some implementations of the disclosed technology.

FIG. 9 is a block diagram of a power charger insert in accordance with some implementations of the disclosed technology.

FIGS. 10A-10I illustrate various power adapters for a power charger insert in accordance with some implementations of the disclosed technology.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Various examples of the disclosed technology will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The disclosed technology is directed to multi-functional camera(s) that can capture images/video with correlative passive infrared (PIR) images and other rich environmental information related to burst events.

Under power-saving mode or within several hours/days of a power outage, the multi-functional camera may remain operational with limited surveillance functions. Although high-power-consuming operations like Wi-Fi and video capturing may be turned off in the event of a power outage, the camera can continue to send/receive data and capture rich environmental data (such as PIR images) for several hours/days to allow applications to continue monitoring the surveillance field.

The disclosed technology of the multi-functional camera contains a power charger insert that can be conveniently plugged into various power adapters for different power supply sources. There are at least two models of the multi-functional wireless camera: a wireless charging model and wired charging model. In addition to the benefits from the smart power-saving feature described above, the wireless model enables low-power wireless charging, which absorbs energy from electromagnetic waves.

The disclosed technology may utilize a low-power Internet of Things (IoT) communication channel as well as a high-speed wireless communication channel, such as 2.4 GHz/5 GHz Wi-Fi. High-power-consuming operations such as video capturing can be activated on demand either by a local low-power sensor or a corresponding command received from the IoT channel, thus resulting in a balance between power-saving and functionalities. Besides the power-saving benefit for a limited power supply scenario, the disclosed technology also provides interoperability among other IoT devices with integrated IoT routing and/or gateway functions.

The disclosed technology can be deployed in both indoor and outdoor surveillance zones. It can be used either independently or as part of other systems, including but not limited to, home security systems and home automation systems.

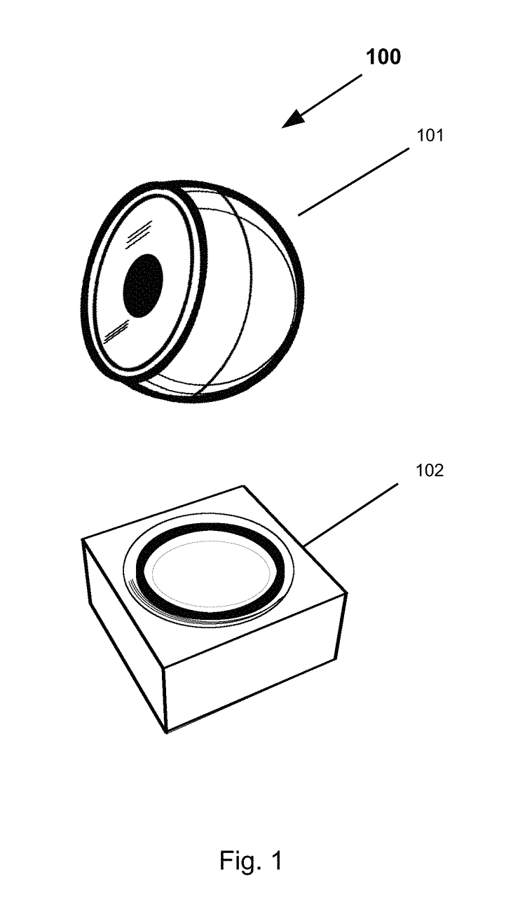

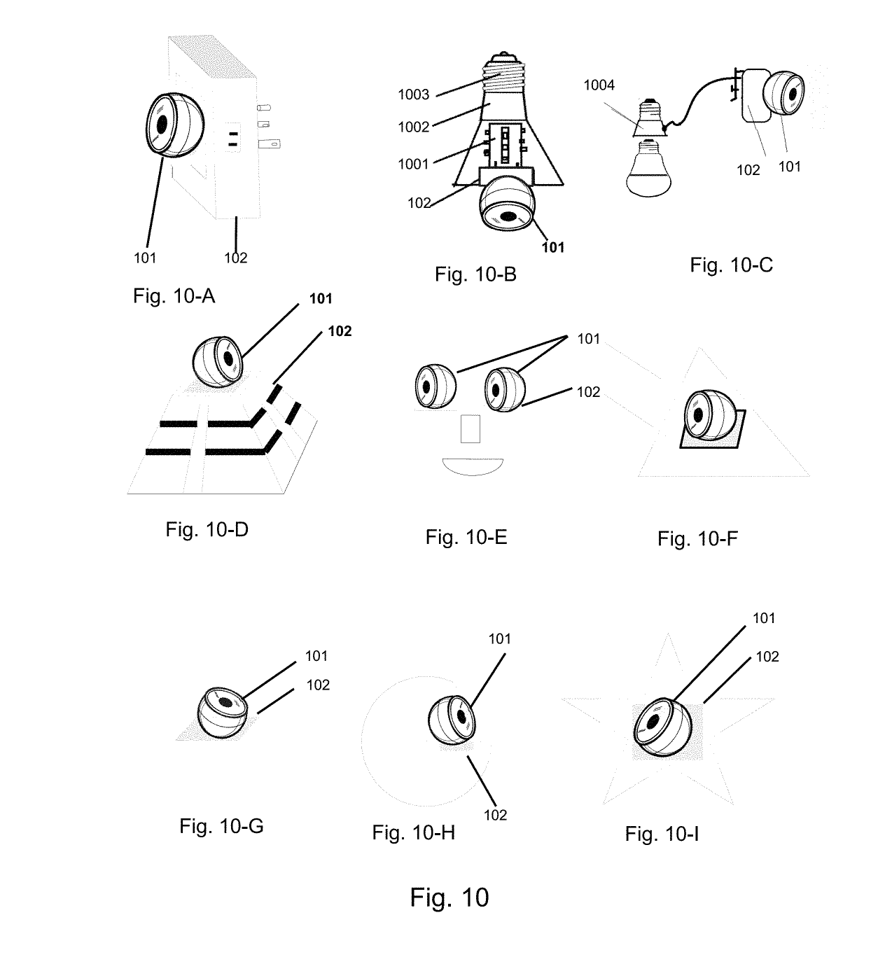

FIG. 1 is an illustration of a wireless charging model of a multi-functional camera 100, which contains a camera body 101, a power charger insert 102 and various power adapters (not shown). The camera body 101 can attach to the power charger insert 102 by magnetic force, making the direction of the camera lens adjustable. The power charger insert 102 can be plugged into various power adapters (e.g., as shown in FIG. 10) for different power supply sources.

The multi-functional camera 100 internally integrates at least an image/video sensor to capture images/video, a PIR sensor array to capture infrared images, one or more microphone(s) to capture sound, and a buzzer and/or speaker for output. The camera body 101 may receive power wirelessly through electromagnetic induction; the electromagnetic wave is generated by either the power charger insert 102 or the transmitter(s) of other wireless charging device(s) nearby.

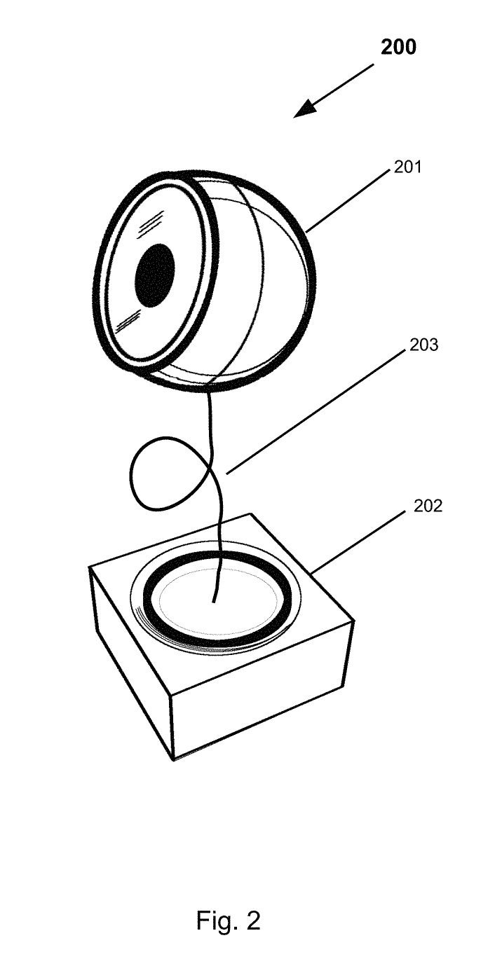

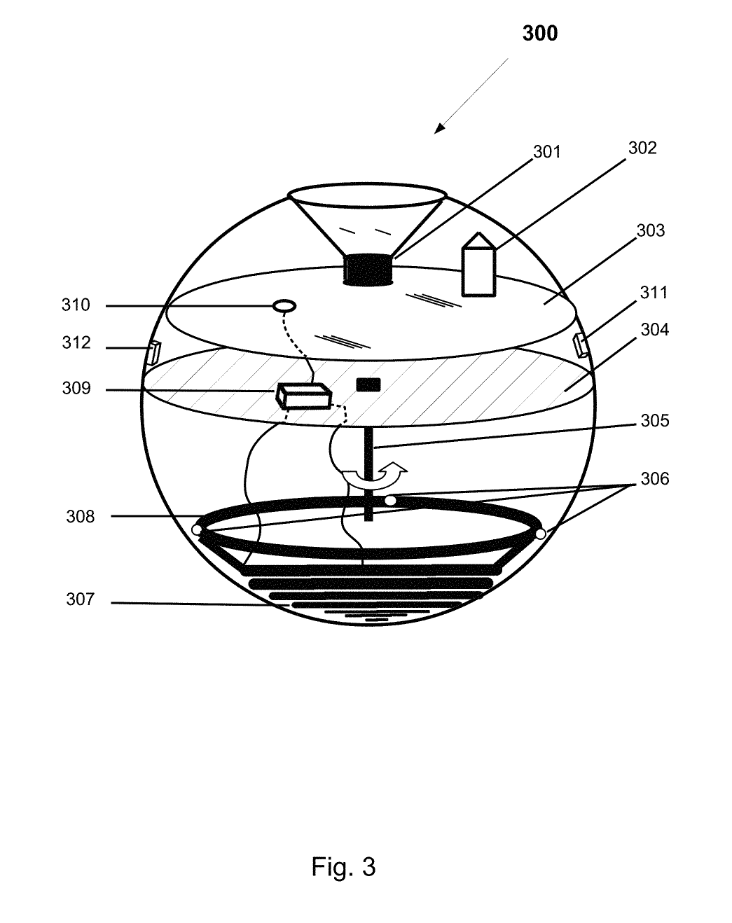

FIG. 2 is an illustration of a wired charging model of the multi-functional camera 200, which contains a camera body 201, a power charger insert 202, an electronic cable 203 and various power adapters (not shown). Compared to FIG. 1, the wired charging model receives power energy from the power charger insert 202 directly via the electronic cable 203. Besides the difference in power transmission method, the multi-functional camera 200 may provide the same functionalities of the multi-functional camera 100. Therefore, FIGS. 3 through 9 primarily illustrate details of a wireless charging model of the multi-functional camera as a super feature set applicable to both cameras 100, 200 or other embodiments as disclosed herein.

FIG. 3 is an illustration of a side view of a camera body 300 (e.g., 101 in FIG. 1 or 201 in FIG. 2) of the disclosed technology. The camera body 300 has a container that includes at least an image/video capturing sensor 301, a sensor housing 303, a PIR sensor array 302, one or more circuit boards 309, and a rotary ring-like frame 308 with multiple socketed magnetic balls 306. For a wireless charging model (e.g., 101 in FIG. 1), a bowl-like electromagnetic wave energy receiver coil 307 attaches to the ring-like frame 308. Besides image/video capturing sensor 301 and PIR sensor array 302, any number of microphone(s) 312, any number of buzzer(s)/speaker(s) 311, and any number of other sensors such as individual PIR sensor 310 can be integrated into the camera body.

In some embodiments, the image/video capturing sensor 301 captures visible images/video, the PIR array module 302 captures invisible passive infrared images, and sensors such as microphone(s) 312 capture sound and other environmental data. Thus, the camera can collect rich information together with corresponding visual scenes. Even if high-power-consuming video capturing operation is turned off, the camera still has the ability to provide information for detection of anomalies.

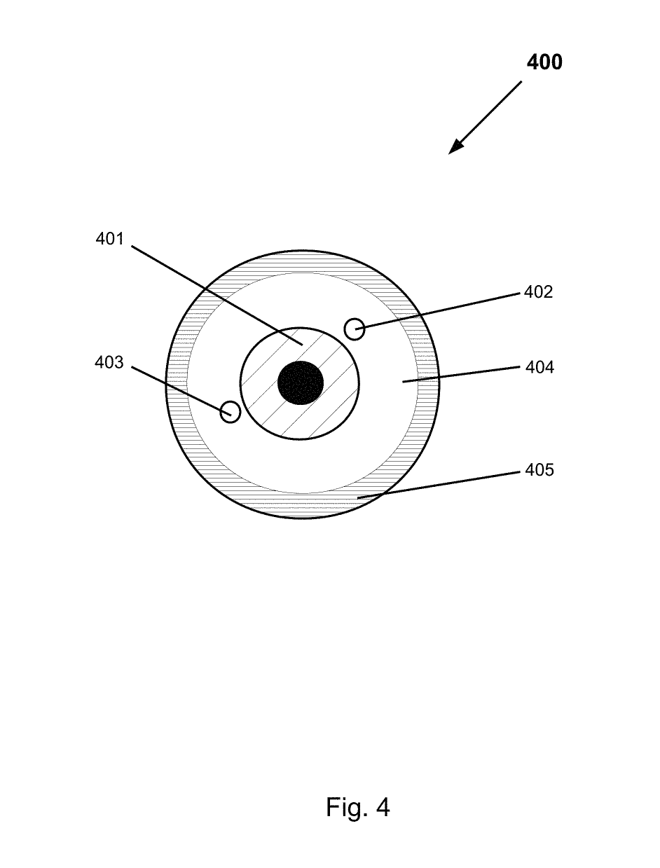

FIG. 4 is an illustration of a top view of a camera body 400 (e.g., 101 in FIG. 1 or 201 in FIG. 2) of the disclosed technology. FIG. 4 depicts at least a lens hood 401, with the camera lens at the center; a PIR sensor array hole 402 that allows the PIR sensor array (e.g., 303 in FIG. 3) to receive passive infrared light; an optional individual PIR sensor 403 (e.g., 304 in FIG. 3); a sensor housing cover 404 (e.g., 302 in FIG. 3); and a container body 405.

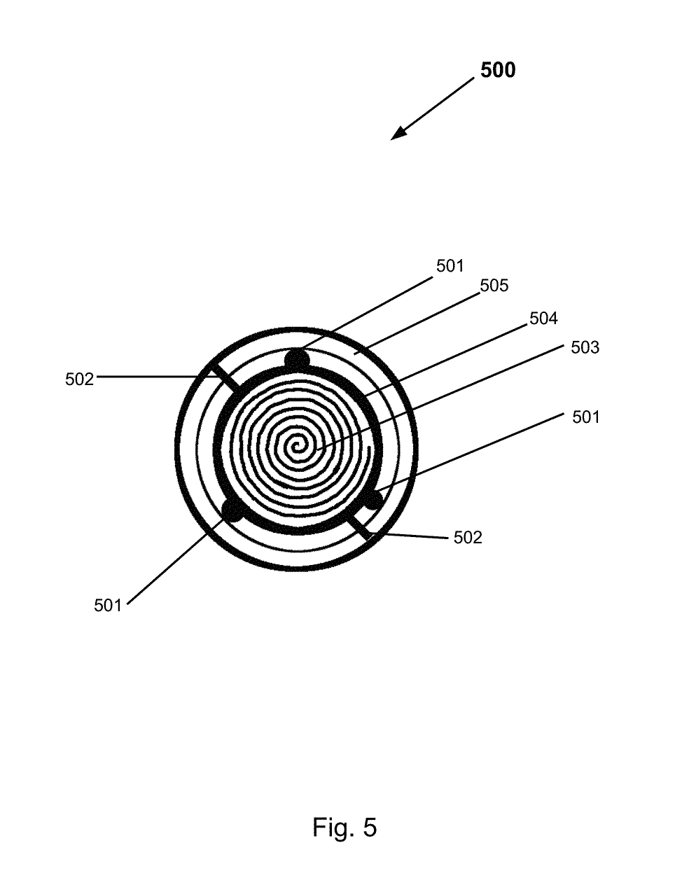

FIG. 5 is an illustration of a bottom view of a camera body 500 (e.g., 101 in FIG. 1 or 201 in FIG. 2) of the disclosed technology. A ring-like frame 504 (e.g., 308 in FIG. 3) holds multiple scrollable magnetic balls 501 (e.g., 306 in FIG. 3). There is a slight gap between the magnetic balls 501 and the container body 505 (e.g., 405 in FIG. 4), and thus the position of the camera body can be adjusted while the ring-like frame 504 remains attracted to the power charger insert (e.g., 102 in FIG. 1 or 202 in FIG. 2) in a horizontal position. For a wireless charging model (e.g., 101 in FIG. 1), a bowl-like electromagnetic wave energy receiver coil 503 (e.g., 307 in FIG. 3) attaches to the ring-like frame 504. With this mechanism, the receiver coil 503 can remain close to the power charger insert (e.g., 102 in FIG. 1) because the ring-like frame 504 can slide around the inner surface of the container body 505. One or more stopper blocks 502 on the inner surface of the container body 505 are designed to limit the movement angles of the ring-like frame 504.

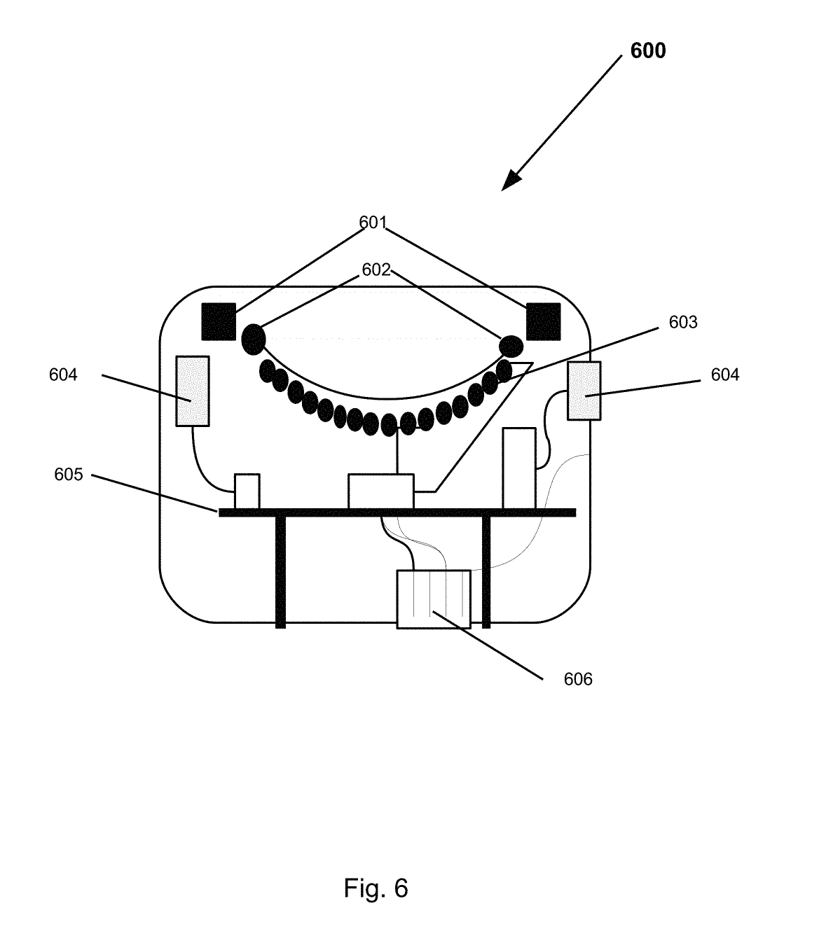

FIG. 6 is an illustration of a side view of a power charger insert 600 (e.g., 102 in FIG. 1 or 202 in FIG. 2). The power charger insert 600 is a base that holds a camera body (e.g., 101 in FIG. 1 or 201 in FIG. 2) by magnetic force. Rubber ring 601 provides water/dust protection as well as additional friction force to hold the camera body in place. A traction ring 602 is made of iron, steel or magnetic material that can attract magnetic balls inside the camera body. Optional sensor(s) 604 connect to a circuit board 605 to collect additional environmental variables (e.g., humidity level). A power socket 606 can be plugged into various power adapters (e.g., as illustrated in FIG. 10). For a wireless charging model (e.g., as illustrated in FIG. 1), a power transmitter coil 603 is included to output power through electromagnetic waves. It should be noted that the transmitter coil 603, including a charge controller module (not shown), can be omitted if the power receiver coil (e.g., 307 of FIG. 3) of the camera body absorbs energy from electromagnetic waves emitted from other wireless transmitter(s) nearby.

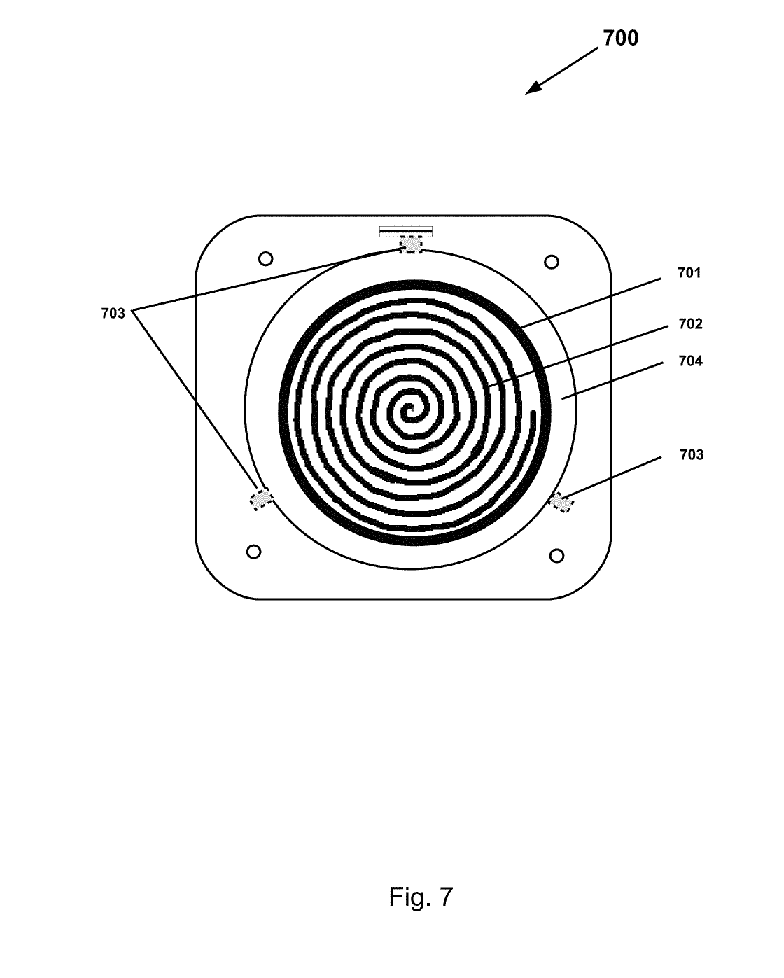

FIG. 7 is an illustration of a top view of a power charger insert 700 (e.g., 102 in FIG. 1 or 202 in FIG. 2). This figure depicts a rubber ring 701 (e.g., 601 in FIG. 6), a transmitter coil 702 (e.g., 603 in FIG. 6, if equipped for the model), magnetic balls 703 (e.g., 501 in FIG. 5) inside a camera body that can be attracted, and a concave surface edge 704 that holds a camera body.

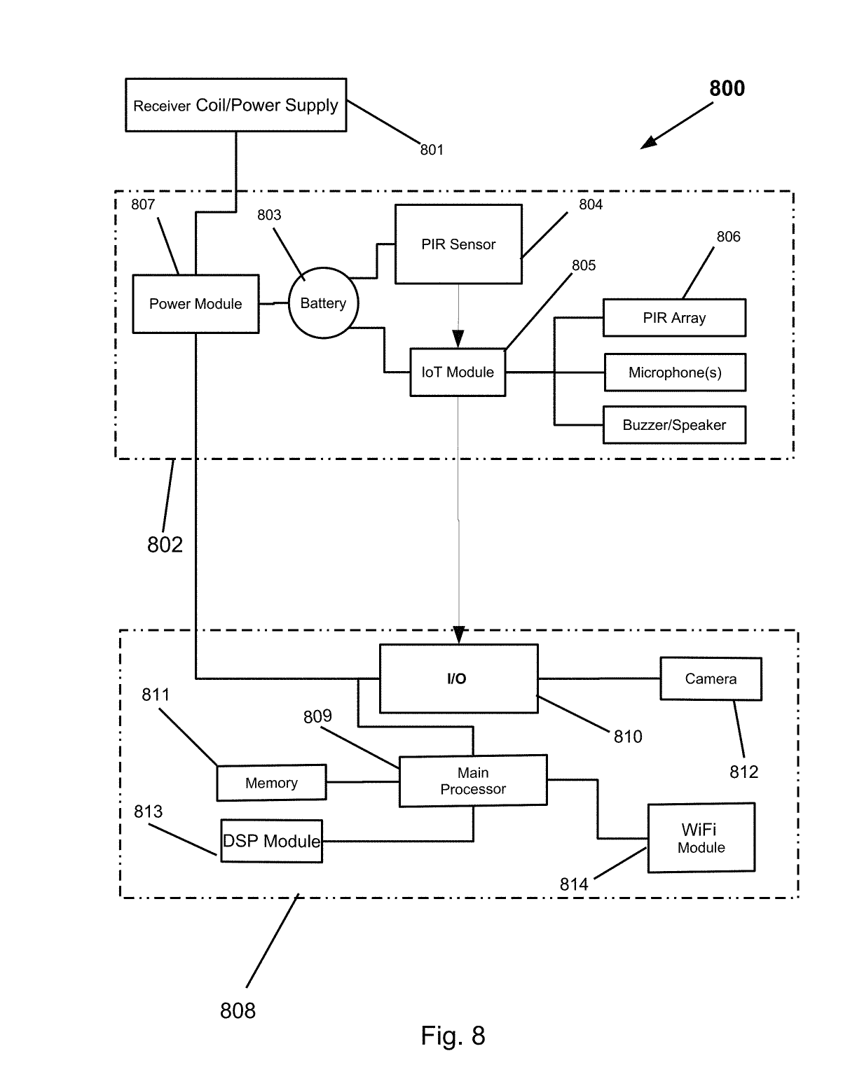

FIG. 8 is a block diagram that illustrates an exemplary hardware structure of a camera body 800 (e.g., 101 in FIG. 1 or 201 in FIG. 2) of the disclosed technology, which includes at least a power supply module 801, an Internet of Things (IoT) sub-system 802, and an image/video capturing sub-system 808. For a wireless charging camera model (e.g., 101 in FIG. 1), the power supply module 801 includes a receiver coil to absorb energy transferred through electromagnetic waves. Otherwise, the power supply module 801 includes a connector for power supply and communication cable.

The IoT sub-system 802 includes at least a power module 807 for power management. A rechargeable battery 803 is utilized for IoT sub-system 802 to work for an additional set number of hours/days under a power outage situation. Individual always-on PIR sensor (or other type of low-power sensor) 804 activates the system whenever a burst event (e.g., the rate or magnitude of changes in certain aspect(s) of environmental variables exceeds a threshold) are detected if the system was in sleep/power-saving mode. The IoT module 805 can be a micro-controller unit (MCU) with an IoT Radio Frequency (RF) component that supports one or more low-power IoT protocol(s), such as Zig-Bee, Bluetooth low energy (BLE), etc. There is at least a PIR sensor array 806 and any number of other variable low-power sensors (e.g., microphones) connected to the IoT module 805 to collect additional environmental data. Output devices such as buzzers and/or speakers may also be utilized by the IoT module to output desired sound/light for testing, status indication, or human interaction.

The image/video capturing sub-system 808 captures images and/or video on demand. The image/video capturing sub-system 808 can be made up of any number of individual electronic components and integrated chips. Illustratively, the image/video capturing sub-system 808 includes a memory 811, a central processing unit (CPU) 809, a Wi-Fi module 814, an input/output (I/O) module 810, and a camera module 812. At least one digital signal processor (DSP) module 813 may be utilized by the sub-system 808 to accelerate image/video processing. The image/video capturing sub-system 808 can be powered by the power module 807 and controlled by the IoT module 805 for power-saving. The image/video capturing sub-system 808 may be completely turned off during power outage.

The IoT sub-system 802 collects basic environmental data and sends/receives commands through a low-power-consuming IoT communication channel that can be supported by the rechargeable battery 803 for several hours/days. Even under a power outage situation, the IoT sub-system 802 may still be able to provide low-resolution motion images captured by the PIR sensor array 806 for software to detect, recognize, or track objects in a surveillance field.

IoT module 805 receives signals from PIR sensor 804, PIR sensor array 806 and/or other sensors inside the IoT sub-system 802. For each signal type (e.g. audio from microphone, PIR sensing image from PIR sensor 804, etc.), a signal burst detection algorithm can be implemented as firmware being executed on IoT module 805. For example, IoT sub-system 802 detects a signal burst when IoT module 805 executes the firmware including the burst detection algorithm to processes audio signals from a microphone to find that during a 100-millisecond window, the audio signal energy exceeds the average energy in past ten 100-millisecond windows by 50%.

Once a burst event is detected or an activation command is received by IoT module 805, the IoT sub-system 802 may send a command to main processor 809 within the image/video capturing sub-system 808 to activate the image/video capturing sub-system 808 into full-functioning mode. Unless not powered up (e.g., during power outage), the main processor 809 informs all parts in the image/video capturing sub-system 808 to wake up from power-saving mode into full-functioning mode. The image/video capturing sub-system 808 continues to be in full-functioning mode if it is already operating in such a mode. Under the full-functioning mode, camera 812 captures higher quality data in visual dimension (e.g., image or video of high-resolution). The higher quality image/video data may be transferred through a high-speed Wi-Fi communication channel (e.g. IEEE 802.11ac over 5 GHz frequency) rather than a low-power IoT communication channel (e.g., via Zig-Bee or BLE protocols) utilized by the IoT sub-system 802.

Burst events expire after a certain amount of time (e.g. 15 seconds). When there are neither unexpired burst events nor unexpired keep-alive command (e.g., a command that instructs the image/video capturing sub-system 808 to remain in full-functioning mode for a certain amount of time) from the IoT module 805, the main processor 809 may choose to enter into power-saving mode. The IoT module 805 may also issue a command to the main processor 809 to enter into power-saving mode. Under the power-saving mode, camera 812 may be either completely turned off or operating to capture lower resolution images with lower frame rate to save on power consumption than under the full-functioning mode. Similarly, Wi-Fi module 814 and other components may also choose to operate with limited functionality and less power consumption under the power-saving mode.

The IoT sub-system 802 may operate as a routing node in a joined IoT wireless network to route IoT data for other network nodes within the same network.

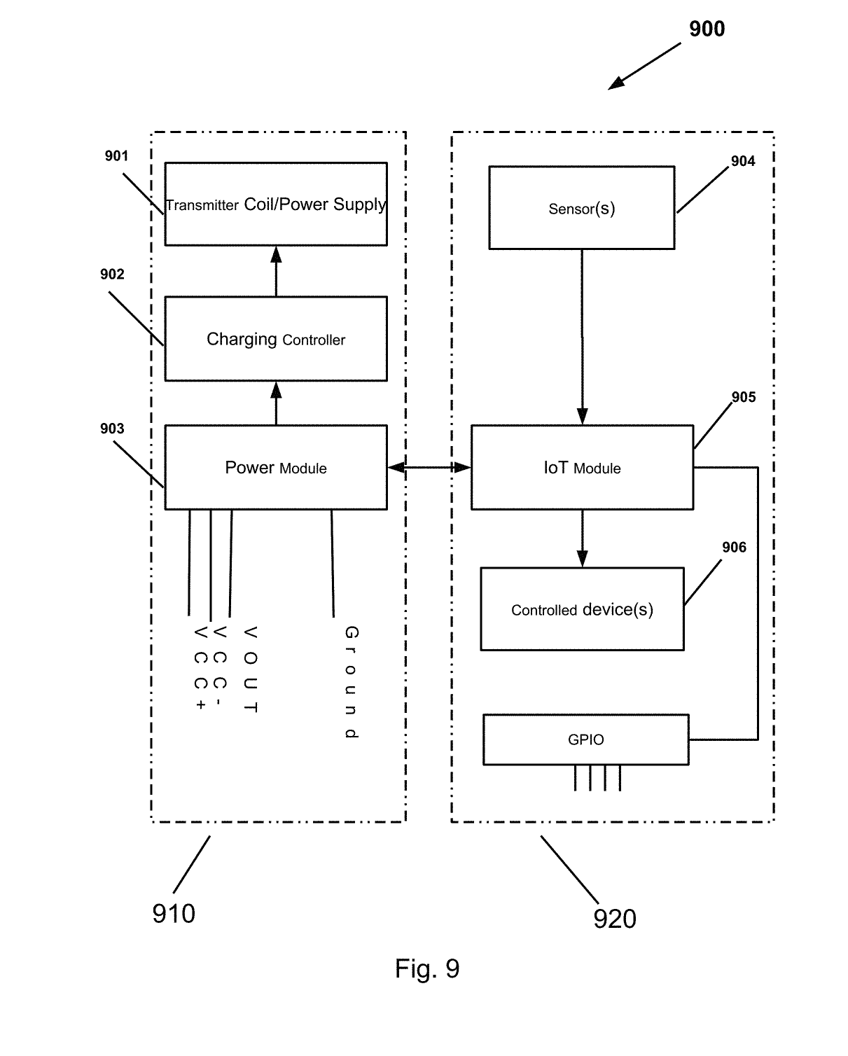

FIG. 9 is a block diagram that illustrates an exemplary architecture of a power charger insert 900 (e.g., 102 in FIG. 1 or 202 in FIG. 2) of the disclosed technology. For a wireless charging model, if the camera body (e.g., 101 in FIG. 1) receives energy from another transmitter nearby, the power charger insert 900 (e.g., 102 in FIG. 1) does not have to contain a wireless power charging component. If the camera body needs to draw power from a base, the power charger insert 900 may include at least a power supply part 910, which can be wireless or wired. For wireless charging, a transmitter coil 901 (e.g., 603 in FIG. 6) transforms energy through electromagnetic waves; otherwise it utilizes an output connector for its power supply and communication cable. A charging controller 902 controls the progress of charging and a power module 903 transforms the input voltage to match the requirements of the charger. The power charger insert 900 may include an IoT sub-system 920 that further includes an IoT module 905 with variable sensor(s) 904 and/or controlled device(s) 906. The IoT module 905 may be configured to collect, via various sensor(s) 904, additional environmental data not conveniently collected by component(s) within a camera body. In some embodiments, the IoT Module 905 may be configured to control device(s) 906, such as an attached light bulb or other household appliances.

FIGS. 10A-10I illustrate various power adapters designed to fit the power charger insert of the disclosed technology. FIG. 10A is an adapter for a wall outlet; FIG. 10B is a bulb-like adapter that acts as a direct replacement of a light bulb, the bulb-like adapter including a cap 1003 that can be screwed into a socket, a housing 1002, and flash LED(s) 2001; FIG. 10C is an adapter with a bulb-socket extender 1004; FIG. 10D is a desktop adapter; FIG. 10E is an adapter for double cameras; and FIGS. 10F, 10F, 10H, and 10I depict various adapter shapes. In FIGS. 10A-10I, camera body 101 may correspond to the camera body 101 in FIG. 1 or 201 in FIG. 2 and power charger insert 102 may correspond to the power charger insert 102 in FIG. 1 or 202 in FIG. 2. For a wireless charging model, which does not require a built-in power supply in the charger insert, the adapter can be used for mounting on a wall, table, etc. without a connection to a power source.

The advantages of the disclosed technology include, without limitation, the efficient collection of image/video data as well as corresponding multi-dimensional environmental data associated with an event that improves accuracy and allows for advanced detection of anomalies, object recognition, tracking and machine learning. Furthermore, the disclosed technology achieves the balance between high-speed data transferring and power-saving, which allows the camera to be charged wirelessly with a low-charging power supply (e.g., <=100 mw). Even under a power outage situation, the camera can still provide limited surveillance functions for the monitored field based upon passive infrared images and sound, etc. This can be helpful for applications such as home security systems. Furthermore, the design of the power charger insert with various adapters simplifies the installation.

In broad embodiment, the disclosed technology is directed to a wireless or wired multi-functional camera for environment variables data collection, including image/video and corresponding multi-dimensional data related to captured image scenes. The multi-functional wireless camera with various power attachment adapters for surveillance applications, may capture visual images/video with corresponding multi-dimensional environmental data that can associate with an event, enable accuracy improvement of abnormality detection, object recognition, tracking and machine learning applications. The multi-functional camera may implement low-power wireless charging, enable limited surveillance under a power outage situation, and allow for simplified installation.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

1. A data capturing device comprising:
one or more processors;
at least one memory;
one or more transmitters;
at least one primary sensor; and
at least one secondary sensor,
wherein the data capturing device stores instructions on the at least one memory that, when executed by the one or more processors, cause the data capturing device to perform operations comprising:
capturing environmental data using the at least one secondary sensor;
transmitting the captured environmental data over a low-power communication channel; and
in response to detecting an event based at least partially on the captured environmental data or receiving a command over the low-power communication channel:
capturing primary data using the at least one primary sensor; and
transmitting the captured primary data over a high-speed communication channel.

2. The data capturing device of claim 1, further comprising a power receiving component comprising at least one electromagnetic wave energy receiver coil that receives power from a base device and provides power to the data capturing device.

3. The data capturing device of claim 2, wherein the data capturing device is at least partially enclosed in a housing and the power receiving component is movable around an inner surface of the housing, wherein the housing conforms to a ball or sphere shape and the power receiving component is attached to a ring-like frame.

4. The data capturing device of claim 1, further comprising a power receiving component attached to a frame comprising magnetic balls that are attractable to a traction ring of a base device.

5. The data capturing device of claim 1, wherein the data capturing device is attachable, via magnetic force, to a base device that provides power to the data capturing device.

6. The data capturing device of claim 5, wherein an orientation of the primary or secondary sensors is adjustable based at least partially on a position of the data capturing device as attached to the base device.

7. A data capturing digital apparatus comprising:
a low-power sub-system including at least one low-power sensor configured to capture environmental data and transmit the environmental data over one or more first communication protocols;
a high-power sub-system including at least one high-power sensor configured to capture detailed data and transmit the detailed data over one or more second communication protocols; and
a power supply component that receives power wirelessly from a base apparatus.

8. The digital apparatus of claim 7, wherein at least the high-power sensor consumes more power than the low-power sensor, the second communication protocols consume more power than the first communication protocols, or the detailed data provides higher resolution than the environmental data.

9. The digital apparatus of claim 7, wherein the power supply component is attached to a ring-like frame.

10. The digital apparatus of claim 7, wherein the power supply component is movable inside a housing of the digital apparatus and attracted to the base apparatus.

11. The digital apparatus of claim 10, wherein the power supply component is attached by magnetic force.

12. A surveillance method comprising:
for a surveillance apparatus having at least one primary sensor and at least one secondary sensor:
capturing environmental data using the at least one secondary sensor; and
transmitting the captured environmental data over a low-power communication channel; and
in response to detecting an event based at least partially on the captured environmental data or receiving a surveillance command:
capturing primary surveillance data using the at least one primary sensor; and
transmitting the captured primary surveillance data over a high-speed communication channel.

13. The method of claim 12, wherein the at least one primary sensor includes a video or image sensor.

14. The method of claim 12, wherein the at least one secondary sensor includes at least one of a passive infrared (PIR) array sensor, individual PIR sensor, or microphone.

15. The method of claim 12, wherein the low-power communication channel corresponds to an Internet of Things communication channel.

16. The method of claim 12, wherein the high-speed communication channel corresponds to a Wi-Fi communication channel.

17. The method of claim 12, wherein the high-speed communication channel is more power-consuming relative to the low-power communication channel.

18. The method of claim 12, wherein the surveillance apparatus captures environmental data using the at least one secondary sensor exclusively during a sleep or power-saving mode.

19. The method of claim 12, further comprising receiving power wirelessly from a base apparatus.

20. The method of claim 19, wherein receiving power wirelessly comprises harvesting energy transferred through electromagnetic waves.
